(19) United States
(12) Patent Application Publication
(10) Pub. No.: US 2008/0015751 A1
(43) Pub. Date: Jan. 17, 2008

(54) SAFETY METHOD OF A STEERING SYSTEM

(75) Inventors: THOMAS RIEPOLD, FRECHEN (DE); SALVATORE OLIVERI, FILSEN (DE)

Correspondence Address: CANTOR COLBURN, LLP, 55 GRIFFIN ROAD SOUTH, BLOOMFIELD, CT, 06002, US

(73) Assignee: TEDRIVE HOLDING BV, Delft (NL)

(21) Appl. No.: 11/777,098

(22) Filed: Jul. 12, 2007

(30) Foreign Application Priority Data
Jul. 13, 2006 (DE) 10 2006 032 683.0
Jun. 8, 2007 (DE) 10 2007 027 040.4

(51) Int. Cl. B62D 6/00; G01M 17/00

(52) U.S. Cl. 701/41

(57) ABSTRACT

The present invention relates to a safety method for monitoring a steering system of a motor vehicle with electric steering support for detecting instabilities and potentially dangerous malfunctions. This has the following method steps: Determining at least one measuring and control quantity of a steering train, Determining at least one measuring and control quantity of a dynamic drive system, Comparison of the determined quantities and checking of the plausibility, Reaction and rendering of the steering in a safe state upon excessive deviation of the determined quantities from the standard quantities.

### TECHNICAL FIELD OF THE INVENTION

The present invention relates to a safety method for monitoring a steering system of a motor vehicle with electric steering support for detection of instabilities and potentially dangerous malfunctions.

### BRIEF DISCUSSION OF RELATED ART

With a conventional steering system, steerable wheels are steered by a driver via an actuation unit, more preferably through twisting a steering wheel. The rotating of the steering wheel causes a displacement of a rack which in turn pivots the wheels. In power steerings the steering movement of the driver is supported through an additional electric motor. Here, the steering support is generally performed through characteristic-controlled or regulated systems where the steering support is applied as a function of the vehicle speed. Compensations such as active return and side wind compensations are likewise implemented.

In addition, steering systems are known where no mechanical connection exists between the steerable wheels and the steering wheel (steer by wire). Here, the wheels are pivoted as a function of the rotational speed of the steering wheel with the help of appropriate motors.

Electric power steering systems generally utilize a separate torque sensor assigned to the steering system for measuring the steering moment applied to the steering wheel by the driver. This torque sensor usually serves exclusively for measuring the torque but can also be combined with an angle-of-rotation- sensor. In addition to this, indirect torque measurement is also known where, via the twisting angle of two parts of the steering column or the steering gear connected with an elastic element designed for this purpose, such as a torsion bar, the torque is determined. Also known is a direct torque measurement on a component of the steering train for example according to a magneto-elastic principle. However, in each case a moment sensor is required which usually is assigned to the power steering (EPAS system) and, if applicable, is integrated in the EPAS system.

Depending on the concept of the control or regulation of the steering system the torque signal is used to amplify the steering commands of the driver in terms of steering support in the same direction of rotation or to adjust a constant torque on the steering wheel in order to give the driver feedback on the steering angle or other dynamic driving parameters.

In the event of failure or malfunctions of the steering actuator system, i.e. sensor system, motor or control unit, the steering system is rendered in a safe or inactive state in which continued mechanical steering of the vehicle is possible. This is done through the monitoring of the internal parameterised measuring and control quantities of the steering system with its actuator system and sensor system.

For example, the vehicle speed signal as input quantity for the speed-dependent characteristics, the steering angle for active return or the engine rotational speed signal as external signals are currently monitored and included in the safety functions.

### BRIEF SUMMARY OF THE INVENTION

The invention comprises developing a method which increases the safety of a vehicle through increasing the detection probability of malfunctions or their quicker detection while increasing the stability and availability of the steering system at the same time.

According to the invention a safety method is provided for monitoring a steering system of a motor vehicle with electric steering support for detecting instabilities and potentially dangerous malfunctions with the process steps:
Determining at least one measuring and control quantity of the steering train,
Determining at least one measuring and control quantity of a dynamic drive system,
Comparison of the determined quantities for plausibility,
Reaction in the event of excessive deviation of the determined quantities and rendering the steering in a safe state.

The invention is based on the idea that the data of the dynamic drive system which are determined anyway are also utilised for monitoring the steering.

Thus, permanent monitoring of the stationary and non-stationary operating behaviour and the stability of the steering system takes place through continuous determination, observation and evaluation of the parameterised measuring and control quantities from the dynamic drive assistance system of the vehicle (e.g. yaw rate, lateral acceleration, steering angle, wheel rotational speed, etc.) and the steering.

Substantial is that modern vehicles are usually equipped with dynamic drive systems anyway which, for example, can influence the stability of the vehicle. Such a dynamic drive system continuously determines data for driver support which, according to the invention, can likewise be utilised. By linking for example slip control, brake and drive stability systems (ABS, ASC, DSC, ESP, etc.) one succeeds in increasing the active safety and the driving comfort, in this way relieving the driver, they help the driver to safely control his vehicle even in critical situations.

Such systems come into action only when for example the tyres are at risk of loosing the adhesion, i.e. before the wheels spin, skid or block. Wheel sensors for example monitor how fast the wheels rotate during the braking operation. If a wheel tends to block the brake pressure on the corresponding wheel brake cylinder is automatically reduced until the wheel returns to running under normal slip.

With the drive slip control, sensors ensure that the drive power during acceleration is transmitted with minimal slip. Regardless of the position of the accelerator pedal, only so much engine power is permitted as is possible in the current driving situation without spinning wheels. By sensing the wheel speeds through sensors this system recognizes if the wheels grip safely. If the driven wheels have a tendency towards spinning, the control intervenes in the engine management and reduces the torque regardless of the current accelerator pedal position.

With the dynamic stability control additional sensors determine additional driving states in order to increase the driving safety during abrupt evasive manoeuvres or sudden danger situations. Expansion of the ABS increases the driving stability particularly when braking in curves.

Sensors determine the yaw rate which indicates how fast the vehicle rotates around its normal axis, the lateral acceleration as dimension for curve radius and speed, the steering angle, which indicates the desired direction and the braking pressure exerted by the driver via the pedal as well as the rotational speed of the individual wheels.

Particularly suitable for utilization according to the invention in safety methods are the wheel rotational speed, the yaw rate and the lateral acceleration

The abovementioned embodiments must only be understood exemplarily, drive dynamic data is also determined and utilized from additional systems.

Through the comparison of the steering function according to the invention with the measuring and control quantities from the dynamic drive system of the vehicle, clearly expanded plausibility considerations compared with the prior art are possible. The invention for example is particularly suitable as additional safety against malfunctions of the electric power steering system which cannot be detected through the safety functions only at steering level or only with difficulty so. Through the detection at vehicle level the detection probability of defects compared with monitoring only at steering level is clearly increased.

At the same time, the introduction of this additional monitoring level with expanded possibilities of plausibility consideration of the system functions, opens up a potential for improvement of the system stability and availability since as a result compromises, which were necessary through the restriction of monitoring of the system stability to only steering level, can be abandoned. Examples for this are the plausibility consideration of the angular signal of the steering angle sensor presented in form of hardware or software through the adjustment with the wheel rotational speeds or the yaw rate.

According to the invention, upon detection of instabilities and potentially dangerous malfunctions, the steering is rendered in a safe state which can lead from the deactivation of certain functionalities of the steering to the complete deactivation of the steering support. However, steerability of the vehicle is always guaranteed through for instance a mechanical reversion level in form of a mechanical connection between the steering wheel and the steered wheels.

The safety method according to the invention is significantly quicker and more reliable than usual failsafe systems.

### BRIEF DESCRIPTION OF THE DRAWING

The invention is explained in more detail by means of the drawing which forms a part of hereof in which:

FIG. 1 is a schematic representation of a safety monitoring system of the operating behaviour.

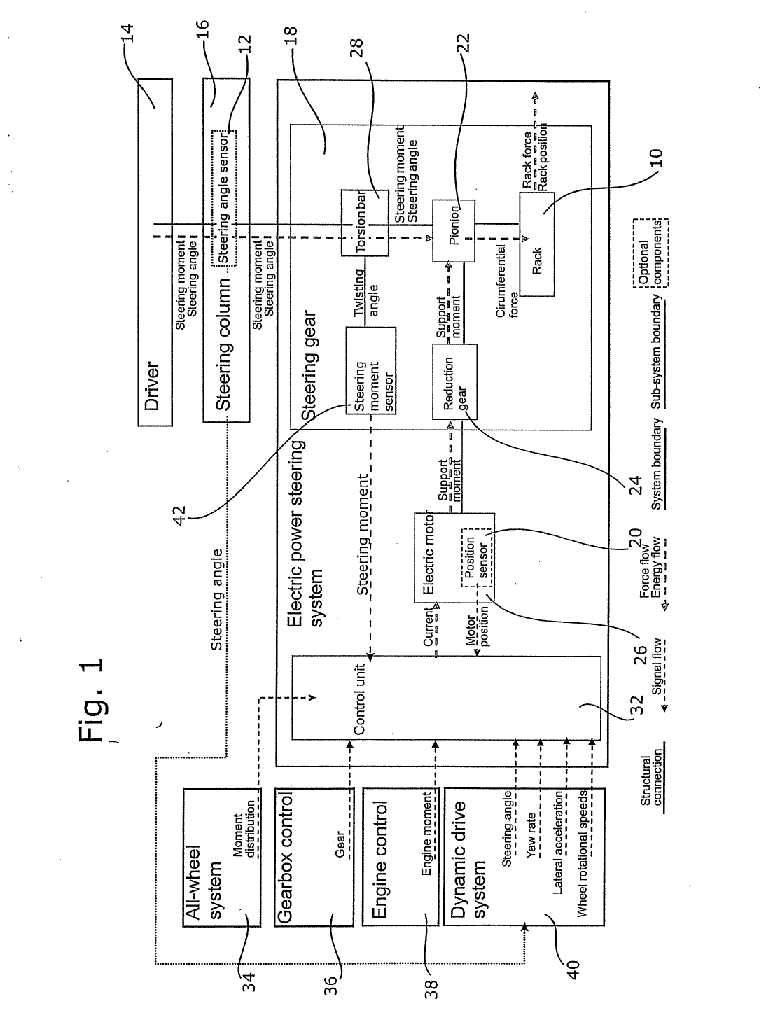

### DETAILED DESCRIPTION OF THE INVENTION

The exemplary embodiment shown serves only as an example and not to restrict the invention.

As can be seen from the associated legend a structural connection, signal flow or force flow or energy flow is possible between the shown components. In addition, system boundaries and sub-system boundaries are represented through different line strengths.

A driver 14 applies a steering moment to a steering gear 18 via a steering column 16. The steering gear 18 has a pinion 22 via which the steering moment is transmitted to the rack 10. Optionally the steering column 16 can have a steering angle sensor 12 according to the state of the art. Alternatively the steering angle sensor 12 can also be arranged in the steering gear 18 or on the rack 10.

The auxiliary moment is generated by an electric motor 26 and transmitted to the rack via a reduction gear 24. The electric motor 26 which supports the rotation of the steering train or a displacement of a rack which pivots the wheels can include a position sensor 20, from which the current position of the wheels or the steering angle can be deducted. Either the steering angle sensor 12 and the position sensor 20 can be provided, but one of the components can be sufficient.

In addition, the steering gear 18 can have a torsion bar 28. Via the torsion bar it is possible to determine a steering moment acting on the steering gear 18 with the help of a steering moment sensor 42.

The values determined through the position sensor 20 are transmitted to a control unit 32. The electric motor 26 is controlled via the control unit 32, thus determines among other things the optimum support moment for the reduction gear 24.

In the exemplary embodiment shown a determined moment distribution of an all-wheel system 34, the determined gear that is engaged of a gear control 36, the determined engine moment of an engine control 38, as well as the steering angle, the yaw rate, the lateral acceleration and the wheel rotational speeds each determined by a dynamic drive system 40 are also transmitted to the control unit 32. In addition, the control unit 32 receives the steering angle determined from the steering angle sensor 12. In addition, the control unit 32 receives the steering moment acting on the steering gear 18 from the steering moment sensor 42.

The control unit 32 compares the input quantities from the dynamic drive systems such as for instance ABS, ASC, DSC, ESP etc. and, upon deviation from the set quantities or on detecting instabilities or malfunctions, renders the steering in a safe state which, following deactivation of certain functionalities of the steering, can lead to the deactivation of the steering support. However, steerability of the vehicle is always guaranteed here for example through a mechanical reverting level in form of a mechanical connection between the steering wheel and the steered wheels.

For the first time the invention allows further evaluation of the measuring and control quantities from the dynamic drive system 40 (ESP, TSC, ABS or similar) of the vehicle which goes beyond processing of the signals necessary for the direct functioning of the steering and serve for the further monitoring of the safety and operating behaviour of the steering. The electric power steering system is integrated in the safety monitoring system for the first time.

The invention is not restricted to the exemplary embodiment described but rather comprises all embodiments having the same effect.

1. A safety method for monitoring a steering system of a motor vehicle with electric steering support for detecting instabilities and potentially dangerous malfunctions, with the process steps:
Determining at least one measuring and control quantity of a steering train,
Determining at least one measuring and control quantity of a dynamic drive system (40),
Comparison of the determined quantities and checking the plausibility,
Reacting and rendering the steering in a safe state in the event of excessive deviation of the determined quantities from the standard quantities.

2. The safety method for monitoring a steering system of a motor vehicle with electric steering support for detecting instabilities and potentially dangerous malfunctions, with the process steps:
Determining at least one measuring and control quantity of the steering train utilising at least one steering moment sensor (42) in the steering train,
Determining at least one measuring and control quantity of a dynamic drive system (40),
Comparison of the determined quantities and checking of the plausibility,
Reacting and rendering the steering in a safe state upon excessive deviation of the determined quantities from standard quantities.

3. The method according to claim 1 or 2, characterized in that a control unit (32) for evaluation of the determined measuring and control quantities is provided.

4. The method according to any one of the claims 1 to 3, characterized in that the dynamic drive system (40) determines data from the group steering angle, yaw rate, lateral acceleration and wheel rotational speed.

5. The method according to any one of the claims 1 to 4, characterized in that the safety system continuously performs a plausibility check of the determined measuring and control quantities and emits a warning signal in the event of implausibilities.

6. The method according to any one of the claims 1 to 5, characterized in that the safety system continuously performs a plausibility check of the determined measuring and control quantities and deactivates the steering system in the event of critical implausibilities.

7. The method according to any one of the claims 1 to 6, characterized in that data of an electric motor (26) with a position sensor (20) are used.

8. The method according to any one of the claims 1 to 6, characterized in that the position of the steering wheel or the steered wheels (26) are sensed by a position sensor (20) in the electric motor or a linear sensor on the rack.

9. The method according to any one of the claims 1 to 8, characterized in that the safety method additionally takes into account a determined moment distribution of an all-wheel system (34).

10. The method according to any one of the claims 1 to 9, characterized in that the safety method additionally takes into account a determined engine moment from an engine control (38).

11. The method according to any one of the claims 1 to 10, characterized in that the safety method additionally takes into account a determined engaged gear of a gear control (36).
